(19) United States
(12) Patent Application Publication
(10) Pub. No.: US 2013/0176632 A1
(43) Pub. Date: Jul. 11, 2013

(54) HABITAT VIEWING DEVICE

(71) Applicant: ECOTECH MARINE, LLC, Bethlehem, PA (US)

(72) Inventors: Patrick CLASEN, Bethlehem, PA (US); Timothy MARKS, Bethlehem, PA (US); Justin LAWYER, Bethlehem, PA (US)

(73) Assignee: ECOTECH MARINE, LLC, Bethlehem, PA (US)

(21) Appl. No.: 13/632,246

(22) Filed: Oct. 1, 2012

Related U.S. Application Data
(60) Provisional application No. 61/541,583, filed on Sep. 30, 2011.

(51) Int. Cl. G02B 25/00

(52) U.S. Cl. CPC G02B 25/002
USPC 359/802

(57) ABSTRACT

A habitat viewing device including an interior magnet, an exterior magnet, and a lens is provided. The interior magnet may be positioned on an interior surface of a habitat wall. The lens includes an exterior magnet attached to the lens. The exterior magnet is magnetically connectable to the interior magnet through the habitat wall.

### CLAIM TO PRIORITY

This application claims the benefit of priority of provisional application Ser. No. 61/541,583, filed Sep. 30, 2011, the disclosure of which is incorporated herein by reference.

### FIELD OF THE INVENTION

The invention relates to viewing devices, especially for viewing a habitat or other environment, and methods of making and using the same.

### BACKGROUND

Animal and plant artificial habitats, for example aquariums, terrariums, green houses, etc., house environments including one or more species of flora and/or fauna, such as fish, invertebrates, amphibians, marine mammals, turtles, plants or any combination thereof. The artificial habitats often include walls to enclose the environment and separate the species from the outside world. The most common of artificial habitats are aquariums which are prominent in homes, restaurants, and office buildings. Aquariums may hold fresh water or marine species of fish, invertebrates, plants, and other species. The habitat walls are typically made of a clear glass or acrylic material.

In certain cases, an observer may wish to obtain a magnified view of species in the artificial habitat. The observer may be performing research and desire a more detailed view or inspection of the species and the habitat. The observer may also simply be a hobbyist who simply wishes to have a closer view.

### SUMMARY

According to a first aspect of the invention, a habitat viewing device includes an interior magnet, a lens, and an exterior magnet. The interior magnet is positioned on an interior surface of a habitat wall. The exterior magnet is attachable to the lens. The exterior magnet and the interior magnet have an effective magnetic attractive force with respect to one another sufficient to magnetically couple the interior magnet with the exterior magnet and mount the lens on an exterior surface of the habitat wall.

According to a second aspect of the invention, a habitat viewing device includes an interior magnet, a lens, and an exterior magnet. The interior magnet is positioned on an interior surface of a habitat wall. The lens includes an outer edge, and the exterior magnet is joined to the outer edge of the lens. The exterior magnet and the interior magnet have an effective magnetic attractive force with respect to one another to mount the lens on an exterior surface of the habitat wall.

According to a third aspect of the invention, a habitat viewing device includes an inner region and an outer region. The inner region includes a magnifying lens. The inner region and the outer region combine to create a top-viewing device having a buoyancy sufficient to float at least a portion of the top-viewing device on water.

According to a third aspect of the invention, a habitat viewing device includes a viewing box having a bottom and a sidewall. A magnifying lens is incorporated into the viewing box.

Other aspects of the invention, including apparatus, devices, kits, methods, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a perspective view of an exemplary habitat.

FIG. 2 is a side, sectional view of a habitat wall and a first exemplary viewing device.

FIG. 3 is a perspective view of the exemplary viewing device shown in FIG. 2.

FIG. 4 is a perspective view of a second exemplary viewing device.

FIG. 5 is a perspective view of a third exemplary viewing device.

FIG. 6 is a perspective view of a fourth exemplary viewing device.

FIG. 7A is a front view of a fifth exemplary viewing device.

FIG. 7B is a side, sectional view of a habitat wall and the exemplary viewing device of FIG. 7A.

FIG. 8A is a front view of a sixth exemplary viewing device.

FIG. 8B is a side, sectional view of a habitat wall and the exemplary viewing device of FIG. 8A.

FIG. 9A is a front view of a seventh exemplary viewing device.

FIG. 9B is a side view of a habitat and the exemplary viewing device of FIG. 9A.

FIG. 10A is a front view of a seventh exemplary viewing device.

FIG. 10B is a side view of a habitat and the exemplary viewing device of FIG. 10A.

FIG. 11 is a front view of a viewing device used in connection with a viewing box.

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

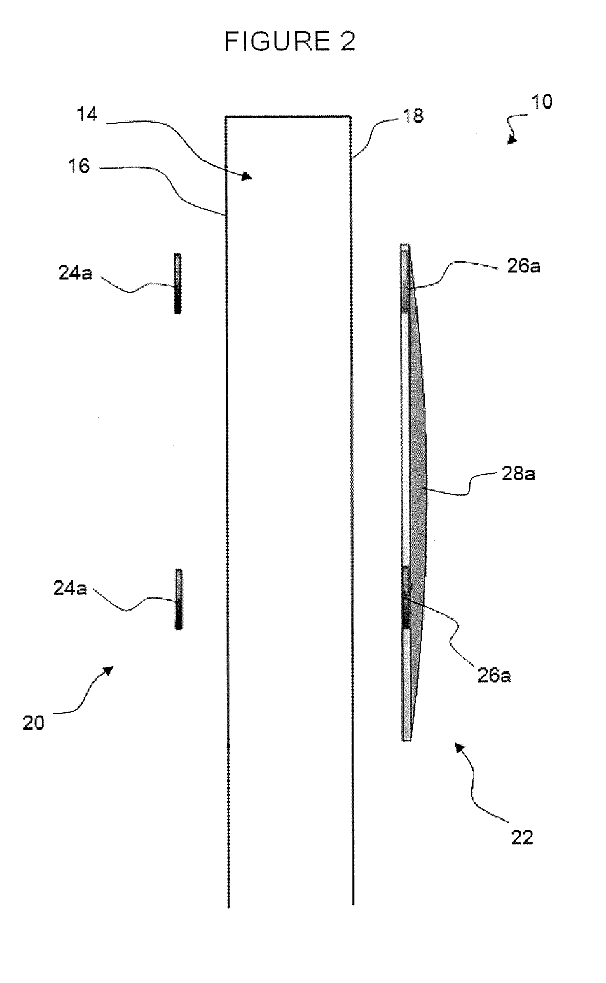

FIGS. 2-11 depict various exemplary embodiments of a viewing device 10. The viewing device 10 enables magnified viewing of an artificial habitat (or “habitat”) 12 or other environment. The viewing device can be used with a variety of habitats including aquariums, terrariums, green houses, etc.

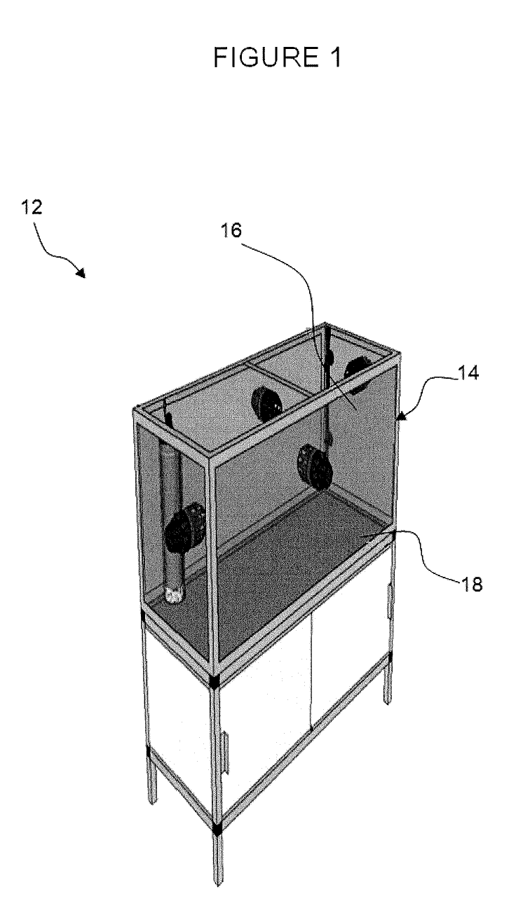

FIG. 1 depicts a habitat 12 in the form of an aquarium with which the viewing device 10 may be used. The habitat 12 may have a variety of shapes, sizes, and configurations. As best shown in FIG. 1, the habitat 12 includes at least one transparent wall 14. The wall 14 has an interior surface 16 and an exterior surface 18. The wall 14 may be completely transparent or may have one or more transparent regions for accommodating the viewing device 10. The viewing device 10 also may be used for viewing objects and environments other than habitats 12. For example, the viewing device may be used with a display case or any other type of housing or panel which includes a transparent wall.

The viewing device 10 is shown in FIG. 2 positioned for assembly on the wall 14 of the habitat 12. The device 10 has a corresponding interior component 20 located inside the habitat 12 and an exterior component 22 located on the opposite side of the wall 14 on the outside of the habitat 12. The interior component 20 is designed to be placed on the interior surface 16 of the wall 14, which is the side closest to the species or environment contained within the habitat 12. The exterior component 22 is designed to be placed on the exterior surface 18 of the wall 14, which is the side closest to a user of the viewing device 10. In certain instances, the interior and exterior components 20, 22 may be switched and placed on opposite sides of the wall 14 than described herein.

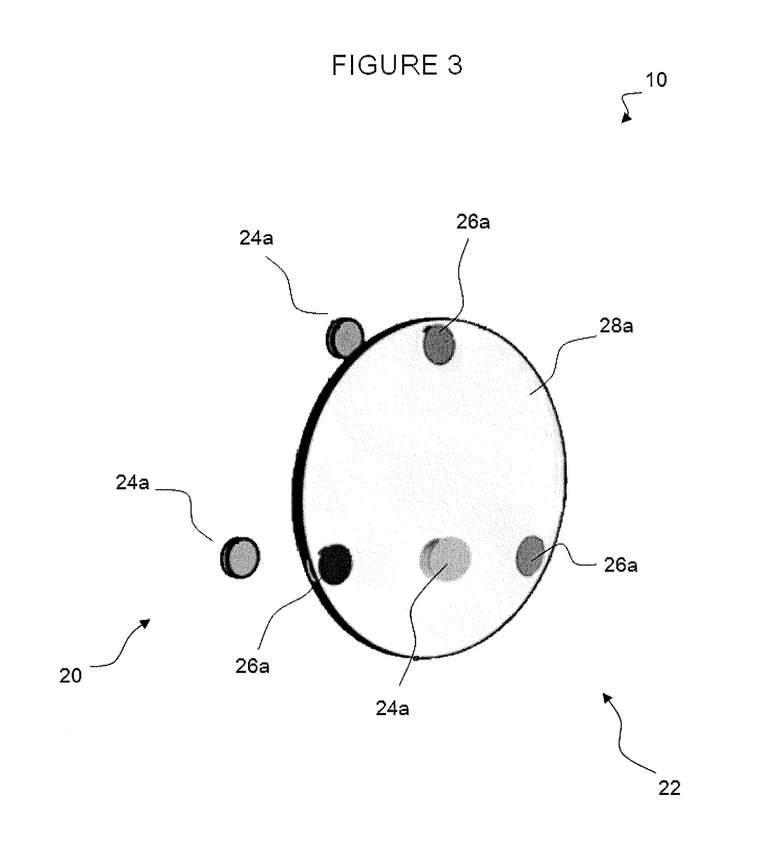

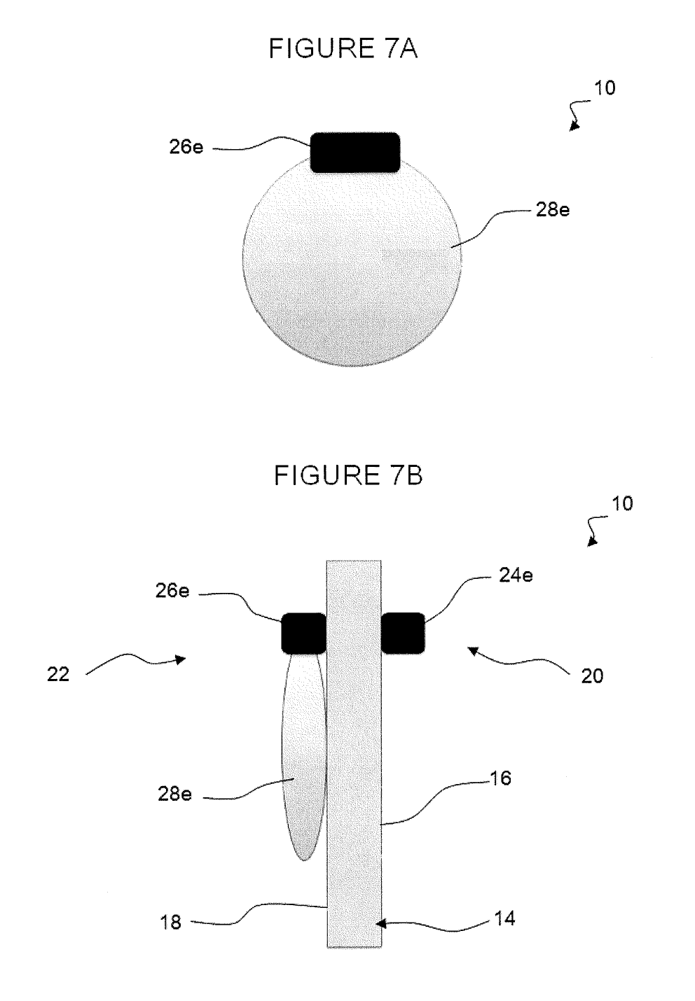

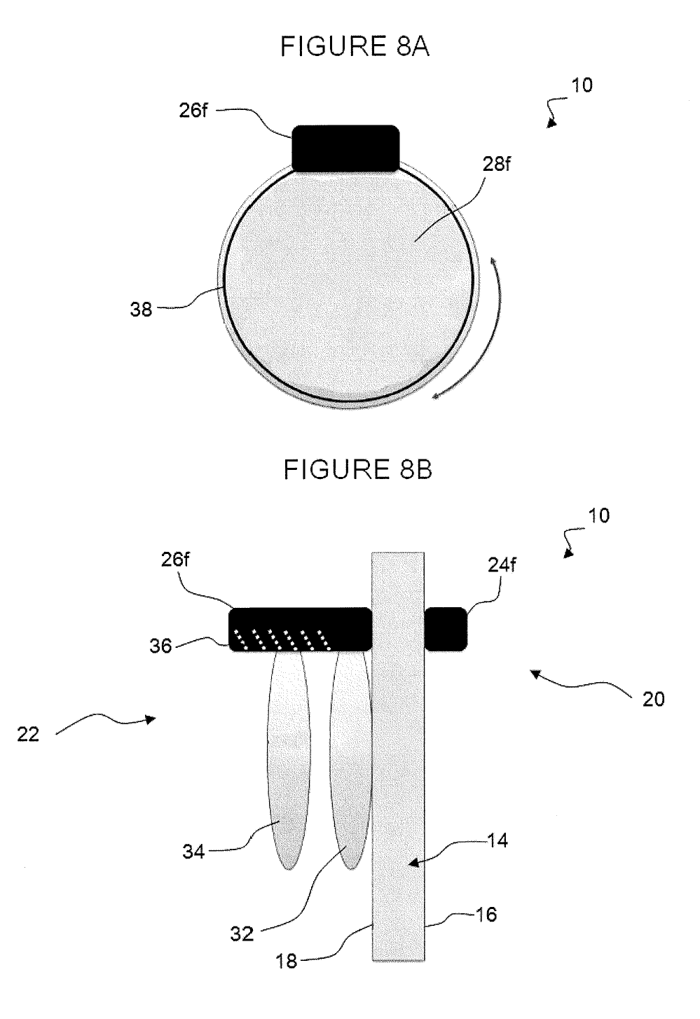

In an exemplary embodiment shown in FIGS. 2 and 3, the interior component 20 includes a set of interior magnets 24a. Though various exemplary embodiments of the viewing device 10 utilize three magnets, one, two, three, four, five or more magnets may be used. For example, a single magnet as shown in the embodiment illustrated in FIGS. 7 and 8. The interior magnets 24a may be attached to the interior surface 16 of the transparent wall 14 in a variety of manners. For example, the attachment may be releasable, such that the interior magnets 24a can be repositioned on the interior surface 16 as desired or needed by a user. Alternatively, the interior magnets may be permanently affixed to or imbedded in the transparent wall 14. Though a single set of interior magnets 24a are shown, multiple sets may be provided at various locations on the wall 14 or on other walls of the habitat 12, including the top and bottom walls.

The interior magnets 24a are constructed and arranged to magnetically attract and engage a set of exterior magnets 26a. For example, the interior magnets 24a are axially polarized, having either a N pole or a S pole facing toward or abutting the interior surface 16, and an opposite pole facing in the other opposite direction. The exterior magnets 26a are also axially polarized, and are arranged so that an opposite pole faces toward or abuts the exterior surface 18. In this way, when the exterior magnets 26a are placed on or in exterior surface 18 of the wall 14 in the vicinity of the interior magnets 24a, which are on or embedded in the interior surface 16, so that the exterior magnets 26a magnetically connect (or “couple”) to the interior magnets 24a. The magnetic connection between the interior magnets 24a and exterior magnets 26a secures the interior component 20 and exterior component 22 to the interior surface 16 and exterior surface 18, respectively.

In the embodiment shown in FIGS. 2 and 3, the exterior component 22 includes a lens 28a. The lens 28 may be, for example, a magnifying lens. The exterior magnets 26a are attached to a lens 28a, for example, permanently or releasably. The lens 28a may be made from glass, polymer such as polycarbonate or polymethyl methacrylate (PMMA), or other transparent or translucent material that allows viewing of the habitat 12 therethrough. The exterior magnets 26a may be permanently attached to the lens 28a, for example, with an adhesive, or be releasably secured thereto, for example, with Velcro®. The exterior magnets 26a also may be embedded in the lens 28a. Embedded is taken to mean that the exterior magnet 26a does not extend outwardly from a surface of the lens 28a placed adjacent the exterior surface 18 of the wall 14. The embedded exterior magnet 26a may be partially surrounded by the lens 28a. For example, the exterior magnet 26a may be adhesively or otherwise secured in a recess of the lens 28a body so that at least a first major surface and a first minor surface are adjacent or in contact with the lens 28a. The embedded exterior magnet 26a may also be completely surrounded by the lens 28a, for example through insert molding with the lens being molded around the exterior magnet 26. The lens 28a is held in place by the magnetic connection between the interior magnets 24a and the exterior magnets 26a. Where the interior magnets 24a are not secured to or embedded in the wall 14, the lens 28a may be repositioned by a user to selectively view different portions of the habitat 12. The user may, for example, slide the lens 28a along the exterior surface 18. The magnetic connection between the magnets 24a and 26a causes the interior magnets 24a to move in tandem with the exterior magnets 26a and the sliding lens 28a. Alternatively, multiple sets of the interior magnets 24a may be secured to or embedded in the wall 14 at different locations alone the interior surface 16, in which case the lens 28a may be selectively moved by the user and connected to the different sets of interior magnets 24a so that different internal regions of the habitat 12 can be selectively viewed.

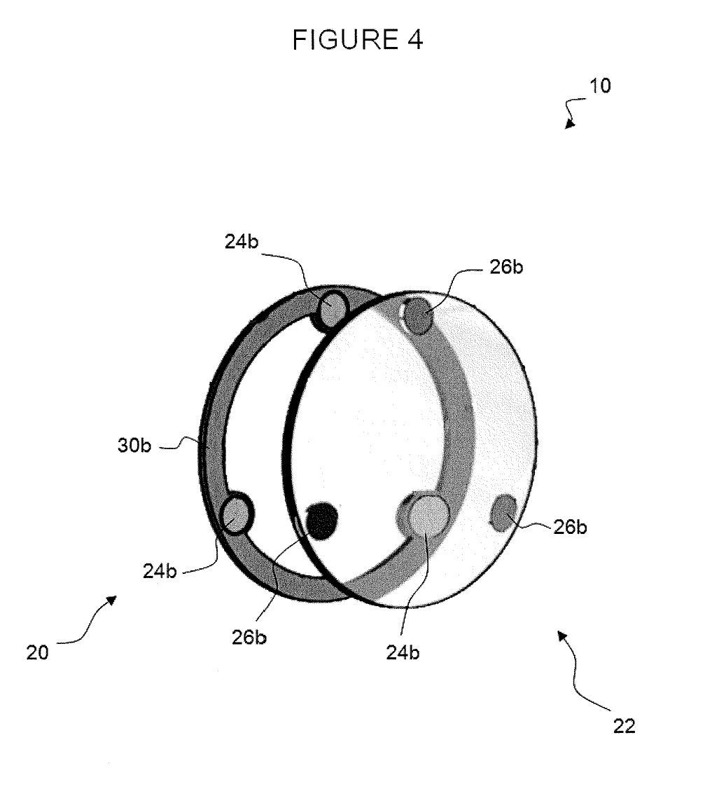

FIG. 4 depicts another exemplary embodiment of the viewing device 10. As shown in FIG. 4, the interior component 20 includes a set of interior magnets 24b attached to a ring 30b. The interior magnets 24b may be releasably or permanently attached to the ring 30b. The interior magnets 24b also may be attached by embedding them in the ring 30b, for example using an adhesive or by insert molding. The ring 30b may be made from and include a variety of materials including vinyl, rubber, neoprene, felt, or other fabric, polymer, elastomer, metal, cellulose, composite materials, or any combination thereof. In an exemplary embodiment, the ring 30b itself may be magnetic, in which case the interior magnets 24b may be eliminated such that the ring 30b forms the interior magnetic component 20 for magnetic connection with the exterior component 22. Alternatively, the interior magnets 24b may have a first surface magnetically connected to the ring 30b and an opposite second surface of opposite polarity that is magnetically attracted to and forms a magnetic connection with the exterior component 22 on the exterior surface 18.

As shown in FIG. 4, the exterior component 22 includes a lens 28b and a set of exterior magnets 26b similar to lens 26a and magnets 26a of the first embodiment shown in FIGS. 2 and 3. The interior magnets 24b are attracted to, and magnetically connected to or couple with the exterior magnets 26b through the wall 14. The lens 28b therefore may be moved about the exterior surface 18 of the wall 14, simultaneously moving the ring 30b which remain magnetically connected to the exterior magnets 26b attached to the sliding lens 28b. In this way, the lens 28b may be repositioned and held in place at any desired point along the wall 14.

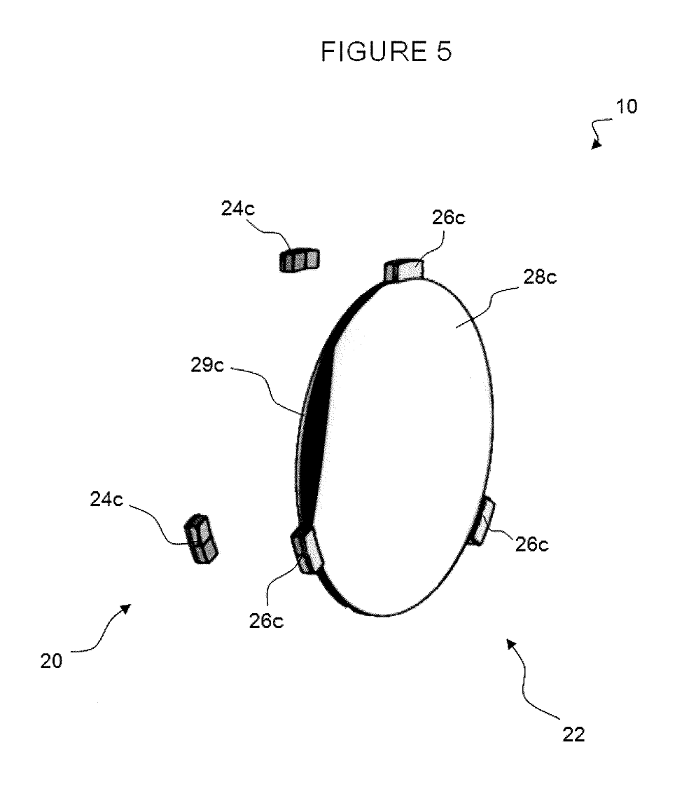

FIG. 5 depicts another exemplary embodiment of the viewing device 10. The exterior component 22 includes a set of exterior magnets 26c joined to the lens 28c, for example on the peripheral edge 29c of the lens 28c as shown in FIG. 5. The exterior magnets 26c and interior magnets 24c (described below) may be bar magnets having a first half with a N polarity and an opposite second half with a S polarity. The exterior magnets 26c may be connected to the lens 28c using an adhesive, frictional fit (with the edge 29c fitted into grooves of the magnets 26c), or may otherwise be releasably or permanently attached to the lens 28c. The exterior magnets 26c magnetically connect to the interior magnets 24c. As shown in above with respect to the first two embodiments, the embodiment of FIG. 5 may include a corresponding number of interior magnets 24c and exterior magnets 26c, with each of the interior magnets 24c being magnetically attached to a corresponding exterior magnet 26c. The interior magnets 24c may be attached to the wall 14 either releasably or permanently, as discussed above with respect to the embodiments of FIGS. 2-4. The interior magnets 24c may be positioned by a user and held in place solely through the magnetic connection with the exterior magnets 26c. A material may be attached to the interior magnets 24c and/or the exterior magnets 26c to act as a backing. For example, a backing plate may be attached to the interior or exterior magnets 24c, 26c. Alternatively, first and second backing plates may be provided for the interior magnets 24c and the exterior magnets 26c, respectively. The backing plate may be made of, for example, steel, plastic, or other materials.

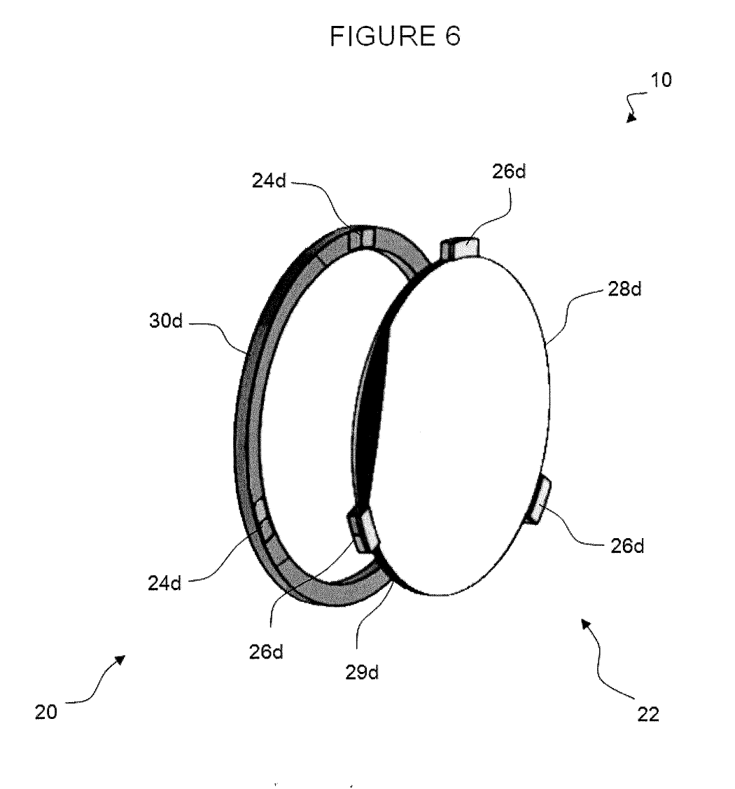

FIG. 6 depicts a modification to the embodiment of the viewing device 10 shown in FIG. 5. In this exemplary embodiment, the interior magnets 24d are joined or otherwise attached to a ring 30d. The interior magnets 24d may be releasably or permanently attached to the ring 30d. The interior magnets 24d also may be attached by embedding them in the ring 30d, for example using an adhesive or by insert molding. The interior magnets 24d may be positioned by a user and held in place (together with the ring 30d attached thereto) solely through the magnetic connection with the exterior magnets 26d. A material may be attached to the interior magnets 24d and/or the exterior magnets 26d to act as a backing. For example first and second steel backing plates may be attached to the interior and exterior magnets 24d, 26d, respectively. The ring 30d may be made from and include a variety of materials including vinyl, rubber, neoprene, felt, or other fabric, polymer, elastomer, metal, cellulose, composite materials, or any combination thereof. In an exemplary embodiment, the ring 30d itself may be magnetic, in which case the interior magnets 24d may be eliminated so that the ring 30d forms the magnetic connection with the exterior magnets 26d of the exterior component 22.

The exterior component 22 includes a set of exterior magnets 26d joined to the lens 28d, for example on the peripheral edge 29d of the lens 28d as shown in FIG. 6. The magnets 24d and 26d may be bar magnets having a first half with a N polarity and a second half with a S polarity. The exterior magnets 26c may be connected to the lens 28c using an adhesive, frictional fit (with the edge 29d fitted into grooves of the magnets 26d), or may otherwise be releasably or permanently attached to the lens 28d.

As best shown in FIGS. 7A and 7B, a single interior magnet 24e may be attached to or placed adjacent the interior surface 16, and a single exterior magnet 26e may be attached or placed adjacent to the exterior surface 18. The interior magnet 24e magnetically connects to the exterior magnet 26e. Various types of magnets may be used for the interior magnet 24e and the exterior magnet 26e. Similar to other exemplary embodiments, the interior magnet 24e may be repositioned along the interior surface 16 of the wall 14. Multiple interior magnets 24e may also be releasably or permanently joined to the interior surface 16 of the wall 14 so that the exterior magnet 26e may be repositioned at different locations, each corresponding to a different interior magnet 24e.

A lens 28e is attached to the exterior magnet 26e. The lens 28e may be releasably attached to the exterior magnet 26e, for example through a clamping mechanism or frictional fit, as discussed above. Various other joints, for example a flange and groove, may be used to releasably or permanently secure the lens 28e to the exterior magnet 26e. The lens 28e may be attached to the exterior magnet 26e by a threaded connection so that the position of the lens 28e may be changed with respect to the wall 14, as discussed in further detail below.

In various exemplary embodiments, the exterior component 22 may include multiple lenses, for example a first lens 32 and a second lens 34 as depicted in FIGS. 8A and 8B. The first and second lenses 32, 34 may be connected to an exterior magnet 26f or magnets as described herein. The exterior magnet 26f magnetically couples with an interior magnet 24f through a wall 14 as also described herein. In various exemplary embodiments, the first lens 32 is stationary with respect to the exterior magnet 26f while the position of the second lens 34 may be adjusted. The second lens 34 may be moved toward or away from the first lens 32, therefore changing the focal length to enable a user to clearly view different depths of the habitat 12. Similarly, the first lens 32 may be moved in addition to the second lens 32 to change the distance from the first lens 32 to the second lens 34 and to the wall 14.

In various exemplary embodiments, the exterior magnet 26f includes internal threads 36. The threads 36 cooperate with a groove 38 in the second lens 34. The second lens 34 may be rotated to change the distance between the first lens 32 and the second lens 34. The exterior magnet 26f also may contain a rotatable cylinder (not shown) with threads on the outer surface of the cylinder. As the cylinder is turned, the first lens 32 and/or the second lens 34 translates along the threads, moving with respect to each other and to the wall 14. Various dials, knobs, wheels, or other mechanisms may be provided to cause movement of the first lens 32 and/or the second lens 34 with respect to each other and to the wall 14 as will be understood by one of ordinary skill in the art upon viewing this disclosure.

The exemplary viewing devices described above provide a number of practical advantages over a typical habitat viewing device. By utilizing magnets, the viewing device 10 may be easily positioned on the wall 14. The magnets also allow the viewing device to be easily repositioned, by sliding the exterior component 22 or by separating the exterior component 22 from the interior component 20 and repositioning. The use of magnets is also advantageous as magnets do not leave marks or smudges that are associated with the use of other connection devices such as suction cups. By joining the exterior magnets 26a-f directly to the lens 28a-f, the viewing device 10 is given a lower profile, enabling a user to better view the habitat 12 through the lens 28a-f. Attaching the exterior magnets 26a-f directly to the lens 28a-f also allows a user to better view the habitat 12 around and outside of the lens 28a-f because additional components, for example housings which may obstruct peripheral viewing, are eliminated. The elimination of additional components also increases the lifespan and durability of the product. Additional components are likely to corrode, rust, or otherwise degrade when used in certain environments. For example, marine aquariums contain a high level of salt content in the water which can speed rust and corrosion of certain metals. Evaporation from the water in a marine aquarium may also leave salt deposits on additional components. This can cause the components to not only corrode faster but also jam or stick where moving parts are involved. In contrast, the viewing device 10 can be made resistant to corrosion and may be easily removed and cleaned.

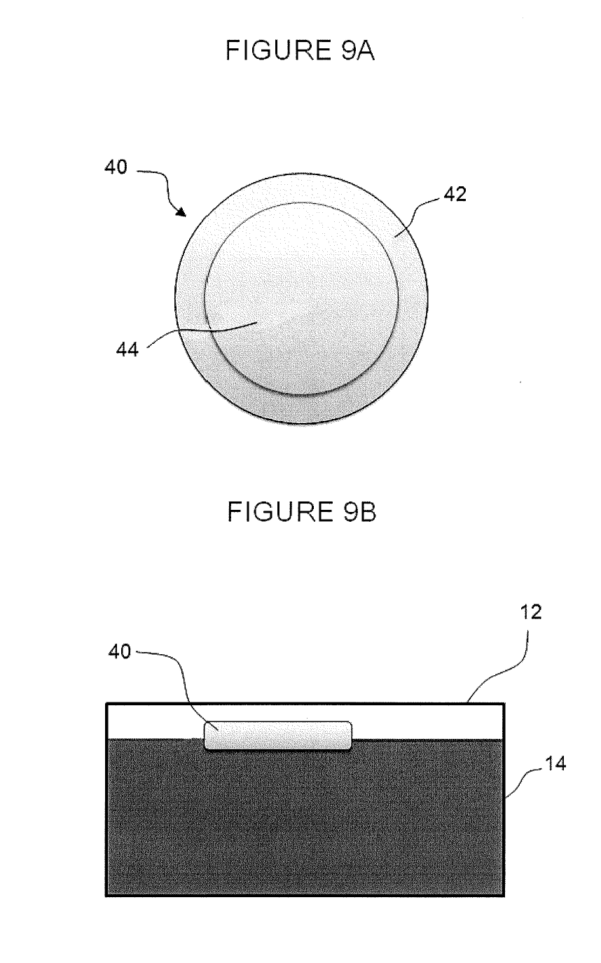

In various other embodiments, the viewing device 10 may be a top-viewing lens 40 as shown in FIGS. 9A-B. Though shown as cylindrical, the top-viewing lens 40 may be any shape. As best shown in FIG. 9A, the top-viewing lens 40 has an outer region 42 and an inner region 44. The outer region 44 includes a cavity which may be empty or supplied with a buoyant substance such as a buoyant material or buoyant fluid. The inner region 44 includes a lens, for example a magnifying lens, for viewing the habitat 12 from above. When used with an aquatic habitat 12, the top-viewing lens 40 may be buoyant enough to float on the surface of the water of the habitat 12 and allow a magnified view of the contents of the aquatic habitat 12. The buoyant substance may include any substance that enhances the buoyancy of the top-viewing lens 40. For example, the buoyant substance may be a material, such as a gel, or a fluid which has a density less than water.

As best shown in FIG. 9B, the top-viewing lens 40 enables a user to look down on the habitat. The top viewing lens 40 can be repositioned on the water surface by the user as desired or needed. Though not shown, various protrusions or handles may be provided on the top viewing lens 40 to facilitate movement of the lens on the surface of the water.

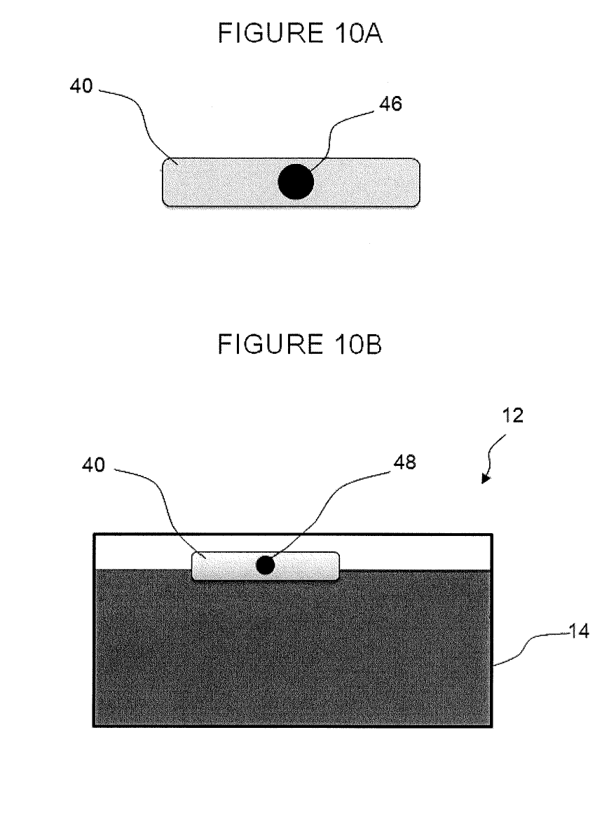

In various exemplary embodiments, the top-viewing lens 40 may be provided with a magnet 46 as best shown in FIGS. 10A-B. The magnet 46 may be embedded in the top-viewing lens 40 or attached thereto. Though a single side magnet 46 is shown, any number of magnets or set of magnets may be used as discussed in connection with various other exemplary embodiments, including those embodiments of FIGS. 1-8 above. The side magnet 46 may connect to an external magnet 48 or a set of external magnets located outside the habitat 12 on the exterior surface 18 of the wall 14, as also discussed in other exemplary embodiments. By utilizing the magnetic connection, the top viewing lens 40 may be held in a specific, though variable, position or utilized when the habitat 12 does not contain water.

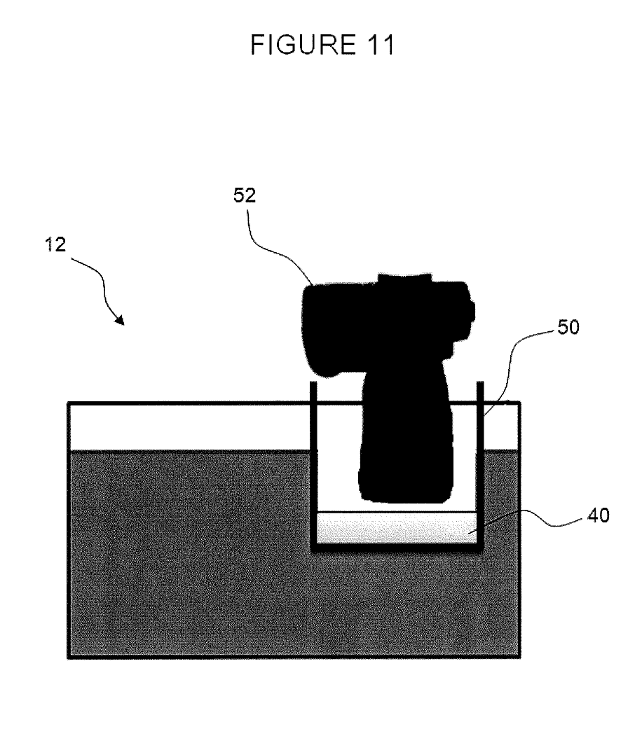

In various exemplary embodiments, the top-viewing lens 40 may be incorporated into a viewing box 50 as shown in FIG. 11. The top-viewing lens 40 may be formed integrally with the viewing box 50, for example, so as to form a bottom wall of the viewing box 50. The top-viewing lens 40 may also be removably placed into the viewing box 50. The viewing box 50 may be sealed so as to be inserted into the water of an aquatic habitat 12. The viewing box 50 may be cylindrical, quadrilateral, or have any number of sides. In various exemplary embodiments, the shape of the viewing box 50 is identical to the shape of the top-viewing lens 40.

The top-viewing lens 40 may be incorporated into the viewing box 50 to provide magnification. The viewing box 50 may receive a camera 52 for taking pictures inside the habitat 12 from under the surface of the water. The viewing box 50 protects the camera 52 from getting wet, so that non-waterproof cameras may be used to take close-up photographs inside the habitat 12. Various filters and/or magnification lenses may be used in connection with the top-viewing lens 40 and the viewing box 50 to provide different affects for the camera. The viewing box 50 may be held in place by a user, through a magnetic connection as discussed herein, or through other mechanical fasteners such as a bracket.

It should be noted that in various exemplary embodiments, the position of the components described above with respect to the interior portions and the exterior portions may be switched and placed on different sides of the wall 14. For example, the lens 28b may be positioned adjacent the interior surface 16 of the wall 14 and the ring 30b may be positioned adjacent the exterior surface 18 of the wall 14. The ring 30b may then be moved by a used to adjust the position of the lens 28b. Other modifications and/or combinations will be understood by one of ordinary skill in the art upon viewing this disclosure.

The viewing device 10 may be used with a variety of different environments and habitats 12. For example, the viewing device 10 may be used to view species in an aquarium or terrarium. The viewing device 10 may be used to inspect plants in a seedling box. The viewing device 10 may also be placed on a window and used to view birds, bugs, or other plants and animals.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. Additional embodiments are possible and are intended to be encompassed within this specification and the scope of the appended claims. The specification describes specific examples to accomplish a more general goal that may be accomplished in another way.

Only those claims which use the words “means for” are to be interpreted under 35 U.S.C. 112, sixth paragraph.

What is claimed:

1. A habitat viewing device comprising:
an interior magnet for positioning on an interior surface of a habitat wall;
a lens; and
an exterior magnet attachable to the lens, the exterior magnet and the interior magnet having an effective magnetic attractive force with respect to one another sufficient for magnetically coupling the interior magnet with the exterior magnet and mounting the lens on an exterior surface of the habitat wall.

2. The habitat viewing device of claim 1, wherein the exterior magnet is embedded in the lens.

3. The habitat viewing device of claim 1, wherein the exterior magnet is adhesively secured to the lens.

4. The habitat viewing device of claim 1, wherein the interior magnet is adhesively connectable to the interior surface.

5. The habitat viewing device of claim 1, further comprising a ring in which the interior magnet is embedded.

6. The habitat viewing device of claim 1, wherein the interior magnet and the exterior magnet are axially polarized.

7. A habitat viewing device comprising:
an interior magnet for positioning on an interior surface of a habitat wall;
a lens comprising an outer edge; and
an exterior magnet attached to the outer edge of the lens, the exterior magnet and the interior magnet having an effective magnetic attractive force with respect to one another to mount the lens on an exterior surface of the habitat wall.

8. The habitat viewing device of claim 7, further comprising a ring in which the interior magnet is embedded.

9. The habitat viewing device of claim 7, wherein the lens is a first lens and the habitat viewing device further comprises a second lens.

10. The habitat viewing device of claim 9, wherein the first lens is fixed relative to the exterior magnet and the second lens is movable with respect to the first lens.

11. The habitat viewing device of claim 10, wherein the second lens is connected to the exterior magnet by a threaded connection.

12. A habitat viewing device comprising:
an inner region comprising a magnifying lens; and
an outer region, the inner and outer region combining to create a top-viewing device having a buoyancy sufficient to float at least a portion of the top-viewing device on water.

13. The habitat viewing device of claim 12, wherein the outer region comprises a hollow cavity.

14. The habitat viewing device of claim 13, wherein the hollow cavity is filled with a buoyant substance.

15. The habitat viewing device of claim 12, wherein the top-viewing device is cylindrical.

16. A habitat viewing device comprising:
a viewing box comprising a bottom and a sidewall; and
a magnifying lens incorporated into the viewing box.

17. The habitat viewing device of claim 16, wherein the magnifying lens is removably positioned in the bottom of the viewing box.

18. The habitat viewing device of claim 16, further comprising a filter placed over the magnifying lens.

19. The habitat viewing device of claim 16, wherein the viewing box is waterproof.

20. The habitat viewing device of claim 16, further comprising a bracket for connecting the viewing box to the side of a habitat.
